(19) United States
(12) Patent Application Publication
(10) Pub. No.: US 2014/0212665 A1
(43) Pub. Date: Jul. 31, 2014

(54) POLYAMIDE-IMIDE COATING MATERIAL AND INSULATED WIRE USING THE SAME

(71) Applicant: Hitachi Metals, Ltd., Tokyo (JP)

(72) Inventors: Takami USHIWATA, Hitachi (JP); Shuta NABESHIMA, Hitachi (JP); Yasuhiro FUNAYAMA, Naka-gun (JP); Yuki HONDA, Hitachi (JP); Hideyuki KIKUCHI, Hitachi (JP)

(73) Assignee: Hitachi Metals, Ltd., Tokyo (JP)

(21) Appl. No.: 14/163,009

(22) Filed: Jan. 24, 2014

(30) Foreign Application Priority Data
Jan. 31, 2013 (JP) 2013-017383

(51) Int. Cl. H01B 3/30

(52) U.S. Cl. CPC H01B 3/303
USPC 428/375; 524/606

(57) ABSTRACT

A polyamide-imide coating material includes a polyamide-imide resin including a repeating unit of a chemical structure represented by the following general formula (1) in a molecular chain, and a solvent for dissolving the polyamide-imide resin

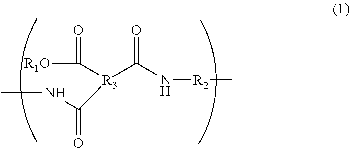

R₁: monovalent organic group
R₂: divalent organic group
R₃: trivalent organic group.

The present application is based on Japanese patent application No. 2013-017383 filed on Jan. 31, 2013, the entire contents of which are incorporated herein by reference.

### BACKGROUND OF THE INVENTION

1. Field of the Invention

The invention relates to a polyamide-imide coating material and an insulated wire using the polyamide-imide coating material.

2. Description of the Related Art

The polyamide-imide coating material is a heat-resistant polymer resin excellent in heat resistance, mechanical characteristics and hydrolysis resistance, etc., and insulated wires provided with a coating film (insulating film) formed by applying and baking such a polyamide-imide coating material are known.

As a method of manufacturing a polyamide-imide coating material, for example, isocyanate method and acid chloride method, etc., are known.

In the acid chloride method, since major components for synthesis are tricarboxylic acid chloride and a diamine component, chloride residues remain in a coating film after applying and baking the resulting polyamide-imide coating material. Accordingly, a refining process which causes an increase in the cost is required to remove the chloride residues, and furthermore, some chloride residues still remain even after refinement, hence, unsuitable for electric/electronic materials.

Therefore, from the viewpoint of manufacturing and productivity, the isocyanate method is widely used, in which polyamide-imide is produced by a synthesis reaction between two major components, trimellitic anhydride (TMA) as an acid component and 4,4′-diphenylmethane diisocyanate (MDI). In the isocyanate method, amide and imide groups are formed by decarboxylation reaction of MDI with TMA and a polyamide-imide structure is directly formed.

In general, a molecular weight of polyamide-imide coating material needs to be increased to some extent so that mechanical characteristics such as flexibility or external appearance after formed into a coating film are improved. However, increasing the molecular weight causes an increase in viscosity and also a resin is likely to become white (solidified or precipitated) when the coating material absorbs moisture from the air, which may result in a significant decrease in coating properties of the coating material.

A non-volatile component concentration could be reduced to solve such a problem but this causes an increase in the amount of solvent used for the polyamide-imide coating material, which increases the cost. In addition, the number of coating applications to obtain the same film thickness is increased in case of such a polyamide-imide coating material, hence, an increase in the manufacturing cost. The non-volatile component concentration in the polyamide-imide coating material is desirably as large as possible in order to reduce the use amount of solvent and the number of coating applications and thereby to allow low-cost production.

As such, it is desirable to provide a polyamide-imide coating material which allows a coating film having good appearance and mechanical characteristics to be formed, is more highly concentrated (a large non-volatile component concentration) while having a low viscosity, and can be manufactured at low cost.

JP-A-H07-216058 and JP-A-2008-016266 propose a method in which polyamide-imide having a low molecular weight is synthesized so that a coating material has a reduced viscosity and a higher concentration. In this method, alcohols, oximes or phenols, etc., are added as a reaction terminator (terminal blocking agent) acting on an isocyanate group during synthesis of polyamide-imide to terminate reaction of an isocyanate component.

JP-A-2009-149757 proposes that an acid component containing trimellitic acid is reacted with an isocyanate component containing an aromatic diisocyanate component in the presence of caprolactam compound to obtain a highly-concentrated polyamide-imide coating material.

Meanwhile, JP-A-S49-041356 proposes a method of synthesizing a highly soluble amide-imide precursor of amic acid ester type.

### SUMMARY OF THE INVENTION

A polyamide-imide coating material which is highly concentrated while having a low viscosity can be obtained, as disclosed in JP-A-H07-216058, JP-A-2008-016266 and JP-A-2009-149757, by using the isocyanate method and terminating the reaction at an early stage after the initiation of polymerization so as to produce a high-concentration polyamide-imide with a low molecular weight.

However, if the polyamide-imide coating material obtained by such a method is applied and baked directly on a conductor to form a coating film, an unreacted isocyanate may cause a foam etc. in the coating film. As a result, the obtained insulated wires often have poor appearance and do not have sufficient mechanical characteristics such as flexibility or insulating properties.

The method of JP-A-S49-041356 requires a refining process such as aqueous cleaning because of using a halide, which cause a high manufacturing cost occurs.

It is an object of the invention to provide a polyamide-imide coating material that allows a coating film having good appearance and mechanical characteristics to be formed, is more highly concentrated while having a low viscosity allowing coating workability to be significantly improved, does not require a refining process and thus allows low-cost production, as well as an insulated wire using the polyamide-imide coating material.

(1) According to one embodiment of the invention, a polyamide-imide coating material comprises:

a polyamide-imide resin comprising a repeating unit of a chemical structure represented by the following general formula (1) in a molecular chain; and

a solvent for dissolving the polyamide-imide resin

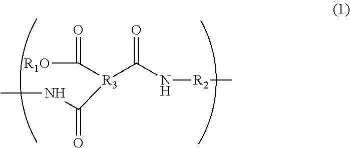

R₁: monovalent organic group
R₂: divalent organic group
R₃: trivalent organic group.

In the above embodiment (1) of the invention, the following modifications and changes can be made.

(i) The chemical structure comprises a chemical structure represented by the following general formula (2):

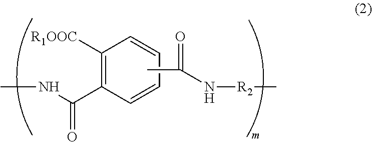

R₁: monovalent organic group
R₂: divalent organic group.

(ii) The polyamide-imide coating material further comprises a repeating unit of a chemical structure represented by the following general formula (3) in a molecular chain, wherein m:n is from 5:95 to 100:0

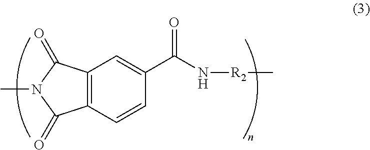

R₂: divalent organic group.

(iii) The polyamide-imide coating material further comprises a viscosity of not more than 3000 mPa·s at a non-volatile component concentration of not less than 30 mass % and a coating material temperature of 30° C.

(iv) The polyamide-imide resin comprises an acid component and a diisocyanate component as an essential raw material, and

wherein the acid component essentially comprises a half-ester of a polyvalent carboxylic acid anhydride.

(v) The acid component comprises the half-ester of polyvalent carboxylic acid anhydride and a trimellitic anhydride at a molar ratio of 10:90 to 100:0.

(vi) The half-ester of polyvalent carboxylic acid anhydride comprises a half-ester of dicarboxylic acid represented by the following general formula (4):

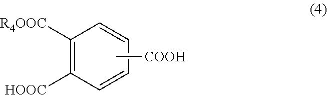

R₄: monovalent organic group.

(vii) The half-ester of dicarboxylic acid comprises one or both of half-esters of dicarboxylic acid represented by the following general formulas (5) and (6):

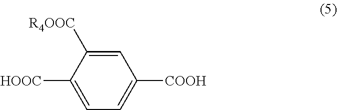

R₄: monovalent organic group

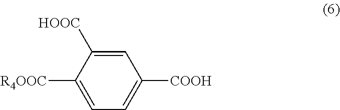

R₄: monovalent organic group.

(viii) The half-ester of dicarboxylic acid comprises a half-ester of a trimellitic anhydride formed by adding an alcohol to the trimellitic anhydride.

(2) According to another embodiment of the invention, an insulated wire comprises a coating film formed by applying and baking the polyamide-imide coating material according to the above embodiment (1).

### Effects of the Invention

According to one embodiment of the invention, a polyamide-imide coating material can be provided that allows a coating film having good appearance and mechanical characteristics to be formed, is more highly concentrated while having a low viscosity allowing coating workability to be significantly improved, does not require a refining process and thus allows low-cost production, as well as an insulated wire using the polyamide-imide coating material.

### BRIEF DESCRIPTION OF THE DRAWINGS

Next, the present invention will be explained in more detail in conjunction with appended drawings, wherein:

FIG. 1 is a cross sectional view showing an insulated wire in which a round conductor is covered with a coating film formed by applying and baking a polyamide-imide coating material in an embodiment of the present invention; and

FIG. 2 is a cross sectional view showing an insulated wire in which a rectangular conductor is covered with a coating film formed by applying and baking the polyamide-imide coating material in the embodiment of the invention.

### DETAILED DESCRIPTION OF THE PREFERRED EMBODIMENTS

An embodiment of the invention will be described below.

The inventors found that, by producing a structure in which an amic acid ester structure is included in a molecular chain backbone of polyamide-imide, it is possible to realize a highly-concentrated polyamide-imide coating material having a low viscosity which allows whitish discoloration of the coating material due to moisture absorption to be suppressed and a coating film excellent in appearance and mechanical characteristics to be formed.

That is, in the polyamide-imide coating material of the present embodiment, a polyamide-imide resin having a repeating unit of a chemical structure represented by the following general formula (1) in a molecular chain is dissolved in a solvent.

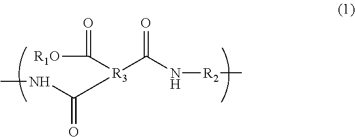

R₁: monovalent organic group
R₂: divalent organic group
R₃: trivalent organic group

The chemical structure of the general formula (1) shows a polyamide-imide resin containing amic acid ester in the backbone. Since the amic acid ester is present in the backbone, the polyamide-imide resin of the general formula (1) has higher solubility than a polyamide-imide resin containing an imide closed-ring structure and an amide group in the backbone and thus can be dissolved at high concentration.

In the polyamide-imide coating material in the present embodiment, the polyamide-imide resin has high solubility and the dissolved polyamide-imide resin thus does not become white (not solidified or precipitated) even when moisture is absorbed from the air, which allows coating workability to be improved.

In order to reduce the use amount of solvent and the number of coating applications and thereby to allow low-cost production, a non-volatile component concentration in the polyamide-imide coating material is preferably not less than 30 mass %. While currently available general polyamide-imide coating materials have a non-volatile component concentration of less than 30%, the polyamide-imide coating material in the present embodiment having the chemical structure of the general formula (1) in the molecular chain uses a resin having high solubility and thus can have a high non-volatile component concentration of not less than 30 mass %.

Furthermore, the polyamide-imide coating material in the present embodiment can realize a low viscosity of not more than 3000 mPa·s at a coating material temperature of 30° C. even when the non-volatile component concentration is 30 mass %. In other words, the polyamide-imide coating material in the present embodiment can have a non-volatile component concentration of not less than 30 mass % even when viscosity at a coating material temperature of 30° C. is 3000 mPa·s.

It should be noted that it is obvious that the polyamide-imide coating material in the present embodiment can be diluted with a solvent and used as a coating material having a non-volatile component concentration of less than 30 mass %. In this case, the solvent used for dilution is a solvent used for forming the polyamide-imide coating material or another suitable solvent which does not degrade solubility or characteristics of coating film.

In the present embodiment, an acid component essentially containing a half-ester of polyvalent carboxylic acid anhydride and a diisocyanate component are used as essential components of a raw material to manufacture the polyamide-imide resin. Here, the half-ester is a compound which is formed by reacting polyvalent carboxylic acid anhydride with alcohol and has an ester and a carboxylic acid or has two carboxylic acids convertible into anhydrides by condensation in the compound such that one of which is present as an ester and another as a carboxylic acid. Producing such a compound is called half-esterification.

By using a compound (a half-ester) formed by half-esterifying a polyvalent carboxylic acid anhydride and a diisocyanate component as raw materials, it is possible to obtain a polyamide-imide resin in which the chemical structure of the general formula (1) is introduced into a molecular chain.

Examples of the diisocyanate component include versatile aromatic diisocyanates such as 2,4′-diphenylmethane diisocyanate (2,4′-MDI), tolylene diisocyanate (TDI), naphthalene diisocyanate, xylylene diisocyanate, biphenyl diisocyanate, diphenylsulfone diisocyanate and diphenylether diisocyanate, and isomers or multimeric complexes thereof, in addition to 4,4′-diphenylmethane diisocyanate (MDI). In addition, aliphatic diisocyanates such as hexamethylene diisocyanate, isophorone diisocyanate, dicyclohexylmethane diisocyanate and xylylene diisocyanate, or alicyclic diisocyanates produced by hydrogenation of the above-mentioned aromatic diisocyanates, and isomers thereof may be used or combined where appropriate. In addition, 2,2-bis[4-(4-isocyanate phenoxy)phenyl]propane (BIPP), bis[4-(4-isocyanate phenoxy)phenyl]sulfone (BIPS), bis[4-(4-isocyanate phenoxy)phenyl]ether (BIPE), fluorene diisocyanate (FDI), 4,4′-bis(4-isocyanate phenoxy)biphenyl and 1,4-bis(4-isocyanate phenoxy)benzene, etc., and isomers thereof can be used as the diisocyanate component. Although a manufacturing method thereof is not specifically limited, a method using phosgene is industrially most suitable and desirable. Aliphatic or alicyclic diisocyanate components may be combined if necessary since effects of reducing permittivity and improving transparency of the resin composition are expected.

The acid component to be used here is manufactured by blending the half-ester of polyvalent carboxylic acid anhydride with a trimellitic anhydride at a molar ratio of 10:90 to 100:0. In other words, in the acid component used here, the half-ester of polyvalent carboxylic acid anhydride and a trimellitic anhydride are blended so that the half-ester of polyvalent carboxylic acid anhydride is contained in a range of not less than 10 mol % and not more than 100 mol %. Hereinafter, the numerical range which is expressed as “A to B” includes “A” and “B”.

The polyvalent carboxylic acid anhydride may be any compounds as long as the molecule thereof has three or more carboxyl groups such that two of which can be converted into anhydrides and are half-esterified thereat.

Examples of the polyvalent carboxylic acid anhydride include trimellitic anhydride and derivatives thereof. In the present embodiment, a half-ester of trimellitic anhydride is used as the half-ester of polyvalent carboxylic acid anhydride and the details thereof will be described later.

A ratio for blending the half-ester of polyvalent carboxylic acid anhydride (the half-ester of trimellitic anhydride) and trimellitic anhydride, which are used as the acid component, may be changed depending on desired characteristics of the polyamide-imide resin. In this regard, solubility of the polyamide-imide resin increases with an increase in the proportion of the half-ester of polyvalent carboxylic acid anhydride and decreases with a decrease in the proportion of the half-ester of polyvalent carboxylic acid anhydride. If the blending ratio of the half-ester of polyvalent carboxylic acid anhydride to trimellitic anhydride is 0:100 to 4:96 as expressed in terms of molar ratio, the proportion of imide closed-ring structure in the molecular chain increases and this causes a decrease in solubility. Therefore, in the acid component, the blending ratio of the half-ester of polyvalent carboxylic acid anhydride to trimellitic anhydride is preferably 5:95 to 100:0 as expressed in terms of molar ratio. From the viewpoint of film forming characteristics associated with solubility and molecular weight, the ratio of the half-ester of polyvalent carboxylic acid anhydride to trimellitic anhydride blended in the acid component is more preferably 10:90 to 70:30 as expressed in terms of molar ratio.

The molecular weight of the polyamide-imide resin to be obtained tends to decrease with an increase in the proportion of the half-ester of polyvalent carboxylic acid anhydride. This may be because heating during polymerization of the polyamide-imide resin causes the half-ester to be converted into an anhydride again and alcohol to separate and the polymerization is blocked by a reaction between the alcohol and the diisocyanate component. It is considered that solubility is further improved since the molecular weight of the polyamide-imide resin is reduced by the blocking reaction. It should be noted that it is presumed that the isocyanate group blocked with alcohol becomes reactive again due to dealcoholization during baking at the time of film formation and thus can participate a part of the film forming reaction, which contributes to an increase in the molecular weight in the coating film and results in that a coating film having good mechanical characteristics such as flexibility is obtained.

Furthermore, reactivity of half-ester during polymerization is mentioned as another factor of molecular weight reduction. In other words, there is a possibility that a carboxylic acid adjacent to an esterified carboxylic acid (the half-ester of polyvalent carboxylic acid anhydride) less reacts with the isocyanate component due to a steric barrier and polymerization is thereby blocked. In this case, it is highly likely that the molecular chain of polyamide-imide is terminated with the half-ester. It is presumed that the half-ester at a molecular chain end is converted into an anhydride again due to dealcoholization during baking at the time of film formation and thus can participate a part of the film forming reaction, which contributes to an increase in the molecular weight in the coating film.

Regarding a blending ratio of the acid component to the diisocyanate component, the total molar quantity of the acid component (X) is preferably substantially equal to a molar quantity of the diisocyanate component (Y) in view of polymerizability. X:Y=100:100 to 100:105, which means the equal amount or slight excess of diisocyanate component, is more desirable since slightly excess diisocyanate component is sometimes advantageous for film formation.

A solvent for reaction of the acid component with the diisocyanate component is a solvent which does not inhibit synthesis reaction of the polyamide-imide resin, such as N-methyl-2-pyrrolidon (NMP), γ-butyrolactone, N,N-dimethylacetamide (DMAc), N,N-dimethylformamide (DMF), dimethylimidazolidinone (DMI), cyclohexanone, methylcyclohexanone and cresol, which may be used in combination thereof.

Although the polyamide-imide resin having a repeating unit of the chemical structure of the general formula (1) in a molecular chain is used in the present embodiment as described above, the chemical structure of the general formula (1) may be replaced with a chemical structure represented by the following general formula (2). The chemical structure of the general formula (2) is based on the general formula (1) but R₃ is replaced by a benzene ring (benzene group).

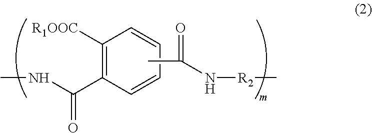

R₁: monovalent organic group
R₂: divalent organic group

The polyamide-imide coating material in the present embodiment uses a polyamide-imide resin in which both the chemical structure represented by the general formula (2) and a chemical structure represented by the following general formula (3) are included as a repeating unit in the molecular chain.

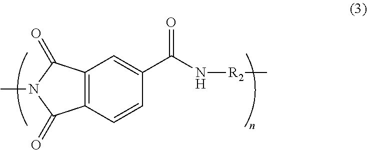

R₂: divalent organic group

The chemical structure of the general formula (2) includes an amic acid ester structure, which improves solubility of the polyamide-imide resin. Meanwhile, the chemical structure of the general formula (3) is an imide closed-ring structure, which improves mechanical characteristics and heat resistance of the polyamide-imide resin. The chemical structure of the general formula (3) is formed by a reaction of, e.g., a diisocyanate component such as MDI with trimellitic anhydride left over after formation of the chemical structure of the general formula (2) or with trimellitic anhydride added afterwards.

A ratio m:n of the chemical structure of the general formula (2) to the chemical structure of the general formula (3) is 5:95 to 100:0. Solubility of the resin increases with an increase in the proportion of the chemical structure of the general formula (2) and the non-volatile component concentration thus can be increased. On the other hand, when the proportion of the chemical structure of the general formula (2) is small and the proportion of the chemical structure of the general formula (3) is large, solubility decreases and viscosity increases. The ratio m:n of the two chemical structure is at least 5:95, and preferably more than 10:90, i.e., the proportion of the chemical structure of the general formula (2) is preferably more than 10%.

When the polyamide-imide resin includes the chemical structure of the general formula (2) in the molecular chain, a half-ester of dicarboxylic acid represented by the following general formula (4) is used as the half-ester of polyvalent carboxylic acid anhydride used for the acid component.

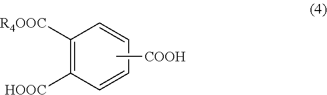

R₄: monovalent organic group

A dicarboxylic acid represented by the following general formula (5) and that represented by the following general formula (6), each in which the 1- or 2-position in trimellitic acid is esterified, are firstly listed as the half-ester of dicarboxylic acid. R₄ is a monovalent organic group and the structure thereof is not limited as long as reactivity during polymerization, solubility after polymerization and imidization efficiency of amic acid ester are not significantly inhibited. A structure easily obtained from alcohols or phenols is more preferable. For example, methyl group, ethyl group, n-propyl group, isopropyl group, n-butyl group, tert-butyl group, isobutyl group, sec-butyl group, n-pentyl group, n-hexyl group, cyclohexyl group, phenyl group and benzyl group, etc., are preferable.

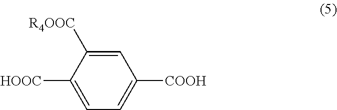

R₄: monovalent organic group

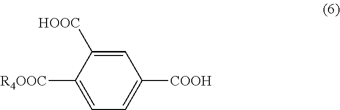

R₄: monovalent organic group

The half-ester of dicarboxylic acid of the general formula (5) and that of the general formula (6) may be combined or used alone. In other words, the half-ester of dicarboxylic acid of the general formula (4) may include a structure represented by one of the general formulas (5) and (6) or may include both structures represented by the general formulas (5) and (6).

As a method of forming the half-ester of dicarboxylic acid of the general formula (5) and that of the general formula (6), adding alcohol to trimellitic anhydride to obtain a half-ester of trimellitic anhydride is easy and low cost as a process.

Alternatively, a dicarboxylic acid produced by esterifying a carboxylic acid at the 2-position in 1,2,3-benzenetricarboxylic acid may be used as the half-ester of dicarboxylic acid of the general formula (4). Also in this structure, it is preferable to use the above-listed groups as R₄. The half-ester of dicarboxylic acid of the general formula (4) may have a single structure or a combination of plural structures.

The polymerization conditions of the diisocyanate component with the acid component composed of the half-ester of dicarboxylic acid of the general formula (4) and trimellitic anhydride are not specifically limited but it is preferable to polymerize in an inert gas such as nitrogen while heating to about 100° C. to 180° C. At this time, in order to suppress runaway polymerization reaction and also to suppress dealcoholization and dehydration of the half-ester of dicarboxylic acid of the general formula (4) caused by heating, it is more desirable to polymerize at about 120 to 160° C. and it is further preferable to take time to increase temperature, from low to high. Alcohols, phenols, amines or carboxylic acids which block the isocyanate groups can be added after polymerization to cool down as well as to terminate the reaction.

An alcohol raw material used to obtain the half-ester of dicarboxylic acid of the general formula (5) and that of the general formula (6) is not specifically limited as long as a hydroxyl group capable of reacting with acid anhydrides is included. Examples thereof includes general alcohols having hydroxyl groups such as methanol, ethanol, n-propanol, isopropanol, n-butanol, tert-butanol, isobutanol, sec-butanol, n-pentanol, n-hexanol, cyclohexanol, benzyl alcohol, diethylene glycol monomethyl ether or 1-methoxy-2-propanol, and phenols can be also used.

By reaction of such an alcohol or phenol with trimellitic anhydride in a solvent, the half-ester of dicarboxylic acid of the general formula (5) and that of the general formula (6) are obtained. The solvent used here may be the reacted alcohol itself as long as solubility thereof is good, or it is possible to use other general solvents such as acetone, tetrahydrofuran, 1,4-dioxane, methyl ethyl ketone (MEK), methyl isobutyl ketone (MTBK), N-methyl-2-pyrrolidon (NMP), N,N-dimethylacetamide (DMAc), N,N-dimethylformamide (DMF), N,N-dimethylsulfoxide (DMSO), cyclohexanone and cresol. The alcohol is reacted with trimellitic anhydride in an inert gas at from room temperature to about 100° C. while, if necessary, being refluxed.

The reaction of trimellitic anhydride with alcohol produces both the half-ester of dicarboxylic acid of the general formula (5) and that of the general formula (6) which may be used as-are without separation, or may be separated by a conventional method so as to be used alone or so as to be used after adjusting a blending ratio of the two types of half-esters.

Furthermore, the polyamide-imide resin may be synthesized such that the half-ester of dicarboxylic acid of the general formula (5) and that of the general formula (6) are produced from trimellitic anhydride and alcohol and subsequently the diisocyanate component is introduced in a state that unreacted alcohol remains. Since the unreacted alcohol blocks the isocyanate group in the diisocyanate component, it is possible to reduce a molecular weight of the polyamide-imide resin to be produced and thus to improve solubility. However, if excess alcohol remains and the molecular weight of the polyamide-imide resin is reduced too much, characteristics of coating film are affected thereby. Therefore, the amount of alcohol in the system needs to be adjusted depending on a balance between coating film characteristics and coating material characteristics.

On the other hand, after producing the half-ester of dicarboxylic acid of the general formula (5) and that of the general formula (6) from trimellitic anhydride and alcohol, the unreacted alcohol may be removed by depressurizing or heating, etc., before introducing the diisocyanate component. In this case, if a low-boiling-point solvent is used, it is possible to easily remove the solvent by depressurizing or heating. It should be noted that it is obviously possible to newly add alcohols in the subsequent polymerization with the diisocyanate component to suppress the degree of polymerization.

Blocked isocyanates, other polyvalent carboxylic acids and epoxy materials, etc., may be added to the polyamide-imide coating material in the present embodiment to improve mechanical characteristics or insulating properties of the coating film, and additives are not limited thereto.

In addition, an imidization accelerator may be added to the polyamide-imide coating material in the present embodiment at the time of forming a polyamide-imide film in order to improve an imidization ratio at the amic acid ester moiety. In addition, adhesive materials to improve adhesion to a base material, a conductor or another film in contact with the coating film, lubricants to improve lubricating properties between the coating film and another material, and inorganic fillers such as particles of silica, alumina, magnesium oxide or magnesium oxide may be added unless characteristics of the coating film are degraded.

Furthermore, the polyamide-imide coating material in the present embodiment may be mixed with other coating materials such as polyester-imide coating materials, other polyamide-imide coating materials, polyimide coating materials, polyester coating materials and unsaturated ester coating materials unless coating properties or characteristics of the coating film are degraded.

Although trimellitic anhydride and the half-ester of dicarboxylic acid are used as the acid component in the present embodiment, tetracarboxylic dianhydride and a half-ester of tetracarboxylic dianhydride may be used instead. Examples of tetracarboxylic dianhydride include pyromellitic acid (PMDA), 3,3′,4,4′-benzophenonetetracarboxylic dianhydride (BTDA), 3,3′,4,4′-diphenyl sulfone-tetracarboxylic dianhydride (DSDA), 4,4′-oxydiphthalic dianhydride (ODPA), 3,3′,4,4′-biphenyltetracarboxylic dianhydride, 4,4′-(2,2′-hexafluoroisopropylidene) diphthalic anhydride (6FDA) and 2,2-bis[4-(3,4-dicarboxyphenoxy) phenyl]propane dianhydride(BPADA), etc., and it is possible to use or combine, if necessary, butanetetracarboxylic dianhydride, 5-(2,5-dioxotetrahydro-3-furanyl)-3-methyl-3-cyclohexene-1,2-dicarboxylic anhydride and alicyclic tetracarboxylic dianhydrides produced by hydrogenation of the above-mentioned tetracarboxylic dianhydrides, etc.

An insulated wire in the present embodiment is provided with a coating film formed by applying and baking the polyamide-imide coating material in the present embodiment.

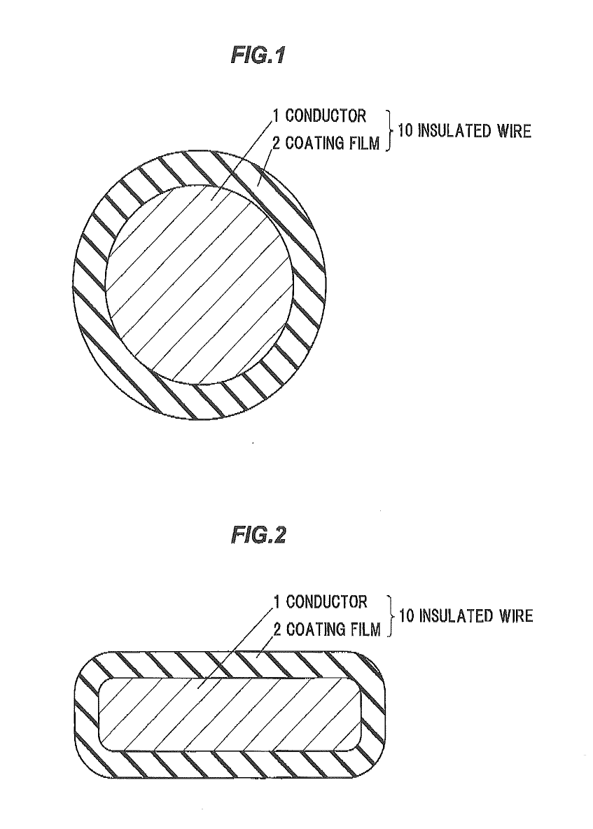

In the present embodiment, the polyamide-imide coating material is applied to a conductor and is then baked in a furnace at, e.g., 350 to 500° C. for 1 to 2 minutes. This process is repeated about 10 to 20 times, thereby obtaining an insulated wire 10 in which an insulating film (referred to as polyamide-imide film) 2 having an increased thickness is formed around an outer periphery of the conductor 1 as shown in FIGS. 1 and 2.

The polyamide-imide coating material in the present embodiment is dealcoholized and imidized at the amic acid ester moiety at the time of calcination. Then, an acid anhydride is produced in a half-ester moiety at the molecular chain end due to dealcoholization, the molecular weight is increased by reaction of the produced acid anhydride with the unreacted isocyanate group or with the isocyanate group which was blocked with alcohol and, presumably, that is why the formed polyamide-imide film has good mechanical characteristics such as flexibility and good appearance.

It is possible to use conductors in various shapes such as a round conductor and a rectangular conductor as shown in FIGS. 1 and 2, respectively. In addition, another film may be present between the conductor and the polyamide-imide film or on an outer periphery of the polyamide-imide film.

For example, providing a film having high adhesion (referred to as adhesive layer) on inner or outer side of the polyamide-imide film allows adhesion between the polyamide-imide film and the conductor or another film to be improved. The adhesive layer is desirably thin to the extent that flexibility or insulating properties of the insulated wire are not impaired, and the thickness of the adhesive layer is, e.g., 1 to 10 μm. In addition, a self-fusing layer may be provided on the polyamide-imide film.

As described above, in the polyamide-imide coating material of the present embodiment, the polyamide-imide resin having a repeating unit of the chemical structure represented by the general formula (1) in a molecular chain is dissolved in a solvent.

Thus, the polyamide-imide resin having a repeating unit of the chemical structure represented by the general formula (1) can realize, due to its high solubility, a polyamide-imide coating material which is highly concentrated while having a low viscosity and does not become white (not solidified or precipitated) even when moisture is absorbed from the air, thereby significantly improving coating workability.

In addition, in the polyamide-imide coating material of the present embodiment, foaming, etc., due to unreacted isocyanate does not occur in the coating film and it is possible to form a coating film having good appearance and mechanical characteristics.

Furthermore, the polyamide-imide coating material in the present embodiment can be manufactured using a half-ester of polyvalent carboxylic acid anhydride, trimellitic anhydride and a diisocyanate component as raw materials without using halides such as tricarboxylic acid chloride, which means that halogen does not practically remain in the polyamide-imide coating material and it is less affected by halogen when formed into a coating film. In addition, complicated refining processes such as aqueous cleaning to remove halogen are not necessary, which allows low-cost production.

It should be noted that the invention is not intended to be limited to the embodiment, and the various kinds of modifications can be made without departing from the gist of the invention.

The polyamide-imide coating material of the invention is applicable for various purposes other than the insulated wire and, for example, a coating film can be formed on a desired base material by applying and baking the polyamide-imide coating material of the invention.

Such a base material is not specifically limited and it is possible to use, e.g., polymer materials, metal materials, glass materials and semiconductor materials, etc. The polyamide-imide coating material applied to such a base material is dried and calcined at an appropriate temperature, about 100 to 300° C., thereby forming a coating film. It should be noted that a method of applying the polyamide-imide coating material is not specifically limited and it is possible to use, e.g., spin-coating method, bar-coating method, roll printing and casting method, etc.

### EXAMPLES

In a flask to which a stirrer, a nitrogen inlet tube, a thermometer and a cooling tube are attached, 525.7 g of trimellitic anhydride (TMA) and 8.8 g of methanol (MeOH) were dissolved in 1167.4 g of N-methyl-2-pyrrolidon (NMP) and were polymerized at 60° C. for 2 hours as a first stage of synthesis reaction. Subsequently, 698.6 g of 4,4′-diphenylmethane diisocyanate (MDI) was introduced and polymerized at 140° C. for 2 hours, then at 150° C. for 1 hour, and furthermore, at 160° C. for 1 hour so as to synthesize a resin including a chemical structure as shown in the general formula (1). After the reaction, a reaction solution was cooled and then 30.0 g of benzyl alcohol for encapsulating the ends of the synthesized resin and 291.9 g of N,N-dimethylformamide (DMF) as a dilution solvent were added thereto, thereby obtaining a polyamide-imide coating material of Example 1. In Example 1, a molar ratio of trimellitic anhydride (TMA) to methanol (MeOH) to 4,4′-diphenylmethane diisocyanate (MDI) is TMA:MeOH:MDI=100:10:102.

Polyamide-imide coating materials of Examples 2 to 13 were made in the same manner, with respective combinations of raw materials shown in Table 1. Meanwhile, in Examples 6 to 8, as shown in Table 1, ethanol, benzyl alcohol and tert-butyl alcohol are respectively used to solve them in place of the methanol (MeOH) in Example 1 for the polymerization reaction so as to synthesize a resin including the chemical structure as shown in the general formula (1).

TABLE 1

| | | Example | | | | | | | |
|---|---|---|---|---|---|---|---|---|---|
| | | 1 | 2 | 3 | 4 | 5 | 6 | 7 | 8 |
| Acid | Trimellitic | 100 | 100 | 100 | 100 | 100 | 100 | 100 | 100 |
| component | anhydride | | | | | | | | |
| | Terephthalic | — | — | — | — | — | — | — | — |
| | acid | | | | | | | | |
| Alcohol | Methanol | 10 | 15 | 20 | 30 | 40 | — | — | — |
| | Ethanol | — | — | — | — | — | 30 | — | — |
| | Benzyl | — | — | — | — | — | — | 30 | — |
| | alcohol | | | | | | | | |
| | tert-butyl | — | — | — | — | — | — | — | 20 |
| | alcohol | | | | | | | | |
| Diisocyanate | MDI | 102 | 102 | 102 | 102 | 102 | 102 | 102 | 102 |
| component | 2,4′-MDI | — | — | — | — | — | — | — | — |
| | TDI | — | — | — | — | — | — | — | — |
| Solvent composition | | NMP: | NMP: | NMP: | NMP: | NMP: | NMP: | NMP: | NMP: |
| | | DMF = | DMF = | DMF = | DMF = | DMF = | DMF = | DMF = | DMF = |
| | | 8:2 | 8:2 | 8:2 | 8:2 | 8:2 | 8:2 | 8:2 | 8:2 |
| Varnish | Mn | 9,700 | 9,700 | 8,900 | 6,900 | 5,400 | 6,500 | 6,300 | 7,200 |
| properties | Mw | 55,800 | 55,800 | 31,200 | 20,800 | 15,600 | 21,200 | 16,200 | 23,100 |
| | Mw/Mn | 5.06 | 5.76 | 3.51 | 3.02 | 2.91 | 3.26 | 2.59 | 3.21 |
| | Concentration | 32.5 | 36.5 | 39.6 | 42.5 | 44.1 | 42 | 41.1 | 40.5 |
| | (mass %) at | | | | | | | | |
| | Viscosity of | | | | | | | | |
| | 3.0 Pa · s | | | | | | | | |
| m:n | | 5:95 | 13:87 | 16:84 | 26:74 | 34:66 | 25:75 | 27:73 | 15:85 |
| Characteristics | Appearance | ◯ | ◯ | ◯ | ◯ | ◯ | ◯ | ◯ | ◯ |
| of | Flexibility | 2d | 1d | 1d | 1d | 1d | 2d | 2d | 2d |
| Insulated wires | | | | | | | | | |

| | | | | | | | Comparative |
|---|---|---|---|---|---|---|---|
| | | Example | | | | | Example |
| | | 9 | 10 | 11 | 12 | 13 | 1 |
| Acid | Trimellitic | 100 | 100 | 100 | 100 | 100 | 100 |
| component | anhydride | | | | | | |
| | Terephthalic | 10 | — | — | — | — | — |
| | acid | | | | | | |
| Alcohol | Methanol | 20 | 20 | 70 | 100 | 30 | — |
| | Ethanol | — | — | — | — | — | — |
| | Benzyl | — | — | — | — | — | — |
| | alcohol | | | | | | |
| | tert-butyl | — | — | — | — | — | — |
| | alcohol | | | | | | |
| Diisocyanate | MDI | 102 | 50 | 102 | 102 | 102 | 102 |
| component | 2,4′-MDI | — | 50 | — | — | — | — |
| | TDI | 12 | — | — | — | — | — |
| Solvent composition | | NMP: | NMP: | NMP: | NMP: | DMAc: | NMP |
| | | DMF = | DMF = | DMF = | DMF = | DMF = | |
| | | 8:2 | 8:2 | 8:2 | 8:2 | 8:2 | |
| Varnish | Mn | 8,200 | 9,100 | 7,500 | 1,900 | 6,700 | 18,400 |
| properties | Mw | 25,800 | 31,300 | 20,000 | 6,600 | 19,900 | 57,300 |
| | Mw/Mn | 3.15 | 3.44 | 2.67 | 3.47 | 2.97 | 3.12 |
| | Concentration | 39.9 | 40.5 | 40.6 | 48.8 | 41.6 | 29.3 |
| | (mass %) at | | | | | | |
| | Viscosity of | | | | | | |
| | 3.0 Pa · s | | | | | | |
| m:n | | — | 17:83 | 61:39 | 95:5 | 28:72 | 0:100 |
| Characteristics | Appearance | ◯ | ◯ | ◯ | ◯ | ◯ | ◯ |
| of | Flexibility | 2d | 1d | 2d | 2d | 2d | 1d |
| Insulated wires | | | | | | | |

It should be noted that, in Examples 11 and 12, a pre-esterified trimellitic acid and a diisocyanate component were blended to synthesize the polyamide-imide coating material. In addition, in Example 13, N,N-dimethylacetamide (DMAc) and N,N-dimethylformamide (DMF) were used as solvents.

Meanwhile, using a typical synthesis process, 788.6 g of trimellitic anhydride and 1047.9 g of 4,4′-diphenylmethane diisocyanate (MDI) were dissolved in 3074.3 g of NMP and were polymerized at 140° C. for 2 hours, and subsequently, 45.2 g of benzyl alcohol for encapsulating the ends of the synthesized resin was added, thereby obtaining a polyamide-imide coating material of Comparative Example 1 for the purpose of comparison.

Varnish properties of Examples 1 to 13 and Comparative Example 1 were evaluated. The evaluated varnish properties are number average molecular weight (Mn), weight-average molecular weight (Mw), a ratio thereof (Mw/Mn) and non-volatile component concentration at a coating material temperature of 30° C. and at a viscosity of 3000 mPa·s (a concentration at a viscosity of 3 Pa·s). Here, the number average molecular weight (Mn) and the weight-average molecular weight (Mw) were measured by a gel permeation chromatography (GPC, using N-methyl-2-pyrrolidon as an eluant). Meanwhile, for the non-volatile component concentration, 1.5 g of the polyamide-imide coating material having a viscosity of 3000 mPa·s at a coating material temperature of 30° C. as measured by an E-type viscometer was heated in an oven at 200° C. for 2 hours to volatilize the solvent and the non-volatile component concentration was derived from a difference between the weight of the remaining non-volatile component and the weight of the non-volatile component before heating.

Then, the polyamide-imide coating materials of Examples 1 to 13 and Comparative Example 1 were applied to 0.8 mm-diameter copper wires by a conventional method and baked in a paint oven at 400° C. for 90 seconds. This process was repeated 15 times, thereby obtaining insulated wires with 35 μm-thick coating film. Then, appearance and flexibility of the obtained insulated wires were evaluated.

An optical particle detector and a microscope were used to evaluate the appearance of the insulated wires. The coating films in which foaming, etc., was observed were evaluated as “X (failed)” and the coating films in which foaming, etc., was not observed were evaluated as “◯ (passed the test)”.

For evaluating flexibility, a round insulated wire was elongated 20% and was wound around a winding bar having a diameter 1 to 10 times a conductor diameter (d) of the insulated wire by a method in accordance with JIS C 3003, and then, the minimum diameter of the winding bar at which defects such as cracks or breakage are not observed by an optical microscope was derived. The result was evaluated as acceptable when the minimum diameter of the winding bar at which defects such as cracks or breakage are not observed in the insulating film was not more than 2d. The evaluation is summarized in Table 1.

As shown in Table 1, the polyamide-imide coating materials of Examples 1 to 13 have a high non-volatile component concentration of not less than 30 mass % at a coating material temperature of 30° C. and at a viscosity of about 3000 mPa·s, while the polyamide-imide coating material of Comparative Example 1 has a small non-volatile component concentration of less than 30 mass % at a coating material temperature of 30° C. and at a viscosity of about 3000 mPa·s.

In addition, the coating films formed using the polyamide-imide coating materials of Examples 1 to 13 have good appearance and are excellent in flexibility, achieving to form coating films which have as good appearance and mechanical characteristics as Comparative Example 1.

What is claimed is:

1. A polyimide-imide coating material, comprising:
a polyamide-imide resin comprising a repeating unit of a chemical structure represented by the following general formula (1) in a molecular chain; and
a solvent for dissolving the polyamide-imide resin 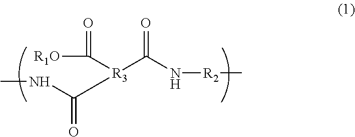
R₁: monovalent organic group
R₂: divalent organic group
R₃: trivalent organic group.

2. The polyamide-imide coating material according to claim 1, wherein the chemical structure comprises a chemical structure represented by the following general formula (2): 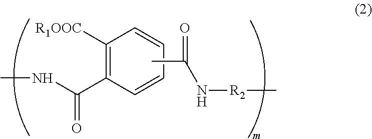
R₁: monovalent organic group
R₂: divalent organic group.

3. The polyamide-imide coating material according to claim 2, further comprising a repeating unit of a chemical structure represented by the following general formula (3) in a molecular chain, wherein m:n is from 5:95 to 100:0 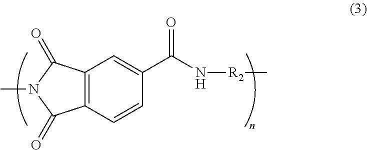
R₂: divalent organic group.

4. The polyamide-imide coating material according to claim 1, further comprising a viscosity of not more than 3000 mPa·s at a non-volatile component concentration of not less than 30 mass % and a coating material temperature of 30° C.

5. The polyamide-imide coating material according to claim 1, wherein the polyamide-imide resin comprises an acid component and a diisocyanate component as an essential raw material, and
wherein the acid component essentially comprises a half-ester of a polyvalent carboxylic acid anhydride.

6. The polyamide-imide coating material according to claim 5, wherein the acid component comprises the half-ester of polyvalent carboxylic acid anhydride and a trimellitic anhydride at a molar ratio of 10:90 to 100:0.

7. The polyamide-imide coating material according to claim 5, wherein the half-ester of polyvalent carboxylic acid anhydride comprises a half-ester of dicarboxylic acid represented by the following general formula (4): 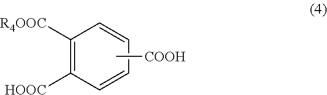
R₄: monovalent organic group.

8. The polyamide-imide coating material according to claim 7, wherein the half-ester of dicarboxylic acid comprises one or both of half-esters of dicarboxylic acid represented by the following general formulas (5) and (6): 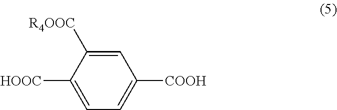
R₄: monovalent organic group 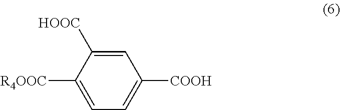
R₄: monovalent organic group.

9. The polyamide-imide coating material according to claim 7, wherein the half-ester of dicarboxylic acid comprises a half-ester of a trimellitic anhydride formed by adding an alcohol to the trimellitic anhydride.

10. An insulated wire, comprising:
a coating film formed by applying and baking the polyamide-imide coating material according to claim 1.
